(19) United States
(12) Patent Application Publication
(10) Pub. No.: US 2009/0105406 A1
(43) Pub. Date: Apr. 23, 2009

(54) USE OF FUNCTIONALIZED POLYVINYL ESTERS FOR INCREASING THE SURFACE TENSION OF BMC/SMC PARTS

(75) Inventor: Rene Graewe, Landshut (DE)

Correspondence Address: BROOKS KUSHMAN P.C., 1000 TOWN CENTER, TWENTY-SECOND FLOOR, SOUTHFIELD, MI, 48075, US

(73) Assignee: WACKER CHEMIE AG, Munich (DE)

(21) Appl. No.: 12/297,772

(22) PCT Filed: Apr. 19, 2007
(86) PCT No.: PCT/EP2007/053854

§ 371 Date: Oct. 20, 2008

(30) Foreign Application Priority Data
Apr. 27, 2006 (DE) 10 2006 019 676.7

(51) Int. Cl. C08L 67/06

(52) U.S. Cl. 524/539

(57) ABSTRACT

Paintability of articles prepared by molding of an unsaturated polyester moulding composition is enhanced by replacing a portion of low-profile additives contained in the composition with solid polyvinyl acetate copolymer(s) containing from 3 to 10 weight percent of monoethylenically unsaturated organic carboxylic acid monomer units.

The invention relates to the use of functionalized polyvinyl esters for increasing the surface tension of BMC/SMC mouldings.

Production of sheet-like plastics parts often uses unsaturated polyester resin compositions (UP resins). These polyester resins are reaction products of a dicarboxylic acid or dicarboxylic anhydride with a polyol. These polyester resin compositions also comprise a monomer having ethylenically unsaturated groups, generally styrene. Styrene is added to the polyester resin composition in order to dissolve the polyester and to ensure that the polyester composition is a flowable material. Fibre materials, such as glass fibre, carbon fibre or corresponding fibre mats, are also present in the polyester resin compositions, in order to reinforce the plastics parts obtained using the polyester resin composition.

A problem with the processing of these polyester resin compositions (Fibre Reinforced Plastic composites=FPR composites) is volume shrinkage when the polyester resin is cured at an elevated temperature. In order to reduce shrinkage during the hardening of the polyester resin, therefore, materials known as low-profile additives are added to the resin. The low-profile additive reduces shrinkage during hardening, dissipates internal stresses, reduces microcracking, and facilitates compliance with manufacturing tolerances. The low-profile additives are thermoplastics, such as polystyrene, polymethyl methacrylate and in particular polyvinyl acetate. Polyvinyl acetates having up to 1% by weight of carboxy-functional comonomer units are also used. At higher content of carboxy-functional comonomer units, shrinkage reduction is unsatisfactory.

Two processes for production of thermoset mouldings from FRP composites are BMC technology (Bulk Moulding Compound) and SMC technology (Sheet Moulding Compound). In the BMC process, the constituents of the compound, the styrenic polyester resin solution, the low-profile additive, the crosslinking catalyst, filler, mould-release agent, and also, if appropriate, further added materials, are mixed to give a paste and then glass fibre is admixed, and then the moulding is produced with exposure to pressure and heat. By way of example, this technology is used to produce reflectors for automobile headlights. In the SMC process, by analogy with the BMC process, a paste is produced from styrenic polyester resin solution, low-profile additive, crosslinking catalyst, filler, mould-release agent, and also, if appropriate, further added materials, and is applied to a polyamide film. Glass fibre is then scattered onto this layer, and finally a further layer of the paste is applied. This sheet-like sandwich is then peeled away from the film, cut into pieces and pressed to mouldings with exposure to pressure and heat. Examples of mouldings produced by means of this technology are tailgates of automobiles.

EP 501176 A1 and DE 102004031968 disclose that the thickening of curable polyester resin moulding compositions can be accelerated via addition of thermoplastic vinyl polymers containing acid groups.

In many cases, however, there is a requirement to paint the resultant mouldings. A disadvantage here is that the surfaces of the mouldings obtained using the technologies mentioned have only low surface tension, a result of this being that the adhesion of the paint layer is inadequate. Surface tension has therefore hitherto been increased prior to painting in an additional operation by means of flame treatment or plasma treatment.

It was therefore an object to modify FRP composites in such a way that they can give mouldings which have increased surface tension.

The invention provides the use of functionalized solid polyvinyl ester resins as additive in unsaturated polyester resin compositions for improving the surface tension of mouldings obtained therefrom.

Suitable vinyl ester monomers for the functionalized solid polyvinyl ester resin are vinyl esters of unbranched or branched carboxylic acids having from 1 to 18 carbon atoms. Preferred vinyl esters are vinyl acetate, vinyl propionate, vinyl butyrate, vinyl 2-ethylhexanoate, vinyl laurate, vinyl pivalate and vinyl esters of α-branched monocarboxylic acids having from 5 to 13 carbon atoms, examples being VeoVa9^{R} or VeoValOR (trademark of Shell) or a mixture of the vinyl ester monomers mentioned. Vinyl acetate is particularly preferred.

Suitable comonomers having functional groups are comonomers having carboxylic acid groups, sulphonic acid groups or phosphonic acid groups. Preference is given to ethylenically unsaturated mono- and dicarboxylic acids, vinylsulphonate and vinylphosphonate. Particular preference is given to acrylic acid, methacrylic acid, fumaric acid and crotonic acid. The proportion of comonomer units having functional groups in the solid polyvinyl ester resin is preferably greater than 1% by weight up to 10% by weight, particularly preferably 3 to 10% by weight, based in each case on the total weight of the solid polyvinyl ester resin.

Most preference is given to solid resins based on vinyl acetate which contain the abovementioned amounts of acrylic acid comonomer units or of crotonic acid comonomer units.

The functionalized solid polyvinyl ester resins are prepared by the bulk, suspension, or preferably solution polymerizations process. Examples of suitable solvents are monohydric, aliphatic alcohols having from 1 to 6 carbon atoms, preferably methanol, ethanol, propanol, isopropanol. Particular preference is given to ethanol and isopropanol. The reaction is generally carried out under reflux conditions, generally at a polymerization temperature of from 40° C. to 140° C., in order to utilize evaporative cooling to dissipate the heat of reaction. This can take place at atmospheric pressure or else at slightly superatmospheric pressure.

Initiators used comprise organic peroxides or azo compounds. Examples of suitable initiators are diacyl peroxides, such as dilauroyl peroxide, peroxoesters, such as tert-butyl peroxopivalate or tert-butyl 2-ethylperoxohexanoate, or peroxodicarbonates, such as diethyl peroxodicarbonate. The amount of initiator is generally from 0.01 to 5.0% by weight, based on the monomers. The initiators can either be used as initial charge or else as a feed. It has proven successful here to use a portion of the necessary amount of initiator as initial charge and to feed the remainder continuously during the reaction.

Molecular weight can be adjusted in a manner known to the person skilled in the art via polymerization in the presence of molecular-weight regulators. Examples of suitable regulators are alcohols, such as ethanol or isopropanol, aldehydes, such as acetaldehyde or propionaldehyde, or silane-containing regulators, such as mercaptosilanes, for example 3-mercaptopropyltrimethoxysilane.

A batch process can be used to prepare the polymers, where all of the components of the polymerization mixture are used as initial charge in the reactor, or a semi-batch process can be used, where individual or a plurality of components are used as initial charge and the remainder is used as a feed, or a continuous polymerization process can be carried out, where the components are used as a feed during the polymerization reaction. The feeds can, if appropriate, be separate (spatially and chronologically).

The formulations of FRP composites for BMC technology (Bulk Moulding Compound) and SMC technology are known to the person skilled in the art. A typical formulation for unsaturated polyester resin compositions for BMC technology and SMC technology comprises 60 to 70 parts by weight of unsaturated polyester resin (in the form of solution of strength from 50 to 75% in styrene), 30 to 40 parts by weight of low-profile additives or polymethyl methacrylate, 0.5 to 2 parts by weight of initiator, such as tert-butyl perbenzoate, 150 to 200 parts by weight of filler, such as calcium carbonate, 25 to 30 parts by weight of glass fibre, 0.5 to 3 parts by weight of mould-release agent, such as zinc stearate, and also, if appropriate, further added materials, for example pigments, thickeners, flame retardants. The formulations preferably comprise no thickeners such as basic metal compounds, e.g. oxides or hydroxides of metals of the 1st to 3rd main group of the Periodic Table of the Elements.

The amount of the functionalized solid polyvinyl ester resin used in the inventive use is from 10 to 80% by weight, preferably from 50 to 80% by weight, based in each case on the amount by weight of low-profile additive in the formulation. It is advantageous here to use this additive in styrenic solution.

Improvement in surface tension means an increase in surface tension. The surface tension of mouldings based on unsaturated polyester resin compositions should preferably be≧35 N/mm², particularly preferably≧38 N/mm², in the inventive use here. Surface tension is generally determined using test inks or test markers to DIN 53364.

The examples below serve for further illustration of the invention:

The following SMC formulations were tested:

| | Inv. | Camp. |
|---|---|---|
| | Ex. 1 (pts. | Ex. 1 (pts. |
| Constituents | by wt.) | by wt.) |
| o-Phthalic UP resin (65% by weight in styrene) | 65.5 | 65.5 |
| Polyvinyl acetate (40% by weight in styrene) | 30.0 | 30.0 |
| VAc-CA copolymer (40% by weight in styrene) | 10.0 | |
| Styrene | 4.5 | 4.5 |
| tert-Butyl peroxybenzoate | 1.5 | 1.5 |
| Zinc stearate | 4.0 | 4.0 |
| Carbon black pigment | 10.0 | 10.0 |
| Calcium carbonate | 200.0 | 200.0 |
| Benzoquinone | 0.3 | 0.3 |
| Process additive (wetting agent, degassing) | 7.9 | 7.9 |
| Magnesium oxide | 2.5 | 2.5 |
| Glass fibre | 90.0 | 90.0 |

Vac-CA copolymer=vinyl acetate-crotonic acid copolymer having 5% by weight of crotonic acid

The formulations were processed as follow to give an SMC moulding:

The constituents of the formulation, except for the magnesium oxide, were mixed in a dissolver to give a paste. After waiting for 5 minutes, the magnesium oxide was incorporated by stirring at a reduced rotation rate. The paste was applied using a 1.5 mm doctor to a polyamide film. The glass fibre was scattered onto the paste layer. A second polyamide film was coated in the same way with paste and then used to cover the glass fibre layer. The layers were compacted by a rolling pin. After 3 days of storage time, the composite was pressed to give a moulding.

The surfaces of the mouldings thus obtained were tested with standard markers (arcotest^{R}) to indicate surface tension.

The surface of mouldings obtained with the composition according to Comparative Example 1 had a surface tension of 34 N/mm². Below 35 N/mm², paint cohesion becomes unsatisfactory.

The surface of mouldings obtained with the composition according to Inventive Example 1 had a surface tension of 38 N/mm².

1.-6. (canceled)

7. In an unsaturated polyester moulding composition wherein a low profile additive is employed, the improvement comprising replacing from 10 to 80% by weight, based on the weight of low-profile additive in the formulation, with at least one carboxy-functional solid polyvinyl acetate resin, effective to improve the surface tension of mouldings obtained therefrom to≧35 N/mm², and wherein the carboxy-functional solid polyvinyl acetate resin contains 3 to 10 weight percent of comonomer units derived from one or more ethylenically monounsaturated mono- or dicarboxylic acids.

8. The composition of claim 7, where the formulation comprises 60 to 70 parts by weight of unsaturated polyester resin in the form of solution of 50 to 75% by weight in styrene, 30 to 40 parts by weight of low-profile additives in the form of a solution of from 30 to 50% by weight in styrene, 0.5 to 2 parts by weight of initiator, 150 to 200 parts by weight of filler, 25 to 30 parts by weight of glass fibre, 0.5 to 3 parts b y weight of mould-release agent, and optionally further added materials.

9. The composition of claim 7, where 50 to 80% by weight, based on the weight of low-profile additive in the formulation, are replaced by at least one carboxy-functional solid polyvinyl ester resin.

10. A process for improving the surface tension of an unsaturated polyester moulding composition containing a low profile additive, comprising replacing from 10 to 80 weight percent of the low-profile additive with a solid polyvinyl acetate resin containing 3 to 10 weight percent of comonomer units derived from one or more ethylenically unsaturated carboxylic acids, to obtain a composition of claim 4, followed by curing the composition.
